(19) United States
(12) Patent Application Publication
(10) Pub. No.: US 2011/0269469 A1
(43) Pub. Date: Nov. 3, 2011

(54) METHOD, APPARATUS AND SYSTEM FOR HANDOVER BETWEEN MULTI-CARRIER CELLS

(75) Inventors: Dengkun Xiao, Beijing (CN); Anjian Li, Beijing (CN); Qing Li, Shenzhen (CN); Jing Han, Beijing (CN); Yuan He, Beijing (CN); Wenjie Wang, Shenzhen (CN); Zhihong Lu, Langfang (CN); Bo Lin, Beijing (CN)

(73) Assignee: HUAWEI TECHNOLOGIES CO., LTD., Shenzhen (CN)

(21) Appl. No.: 13/180,793

(22) Filed: Jul. 12, 2011

Related U.S. Application Data
(63) Continuation of application No. PCT/CN2009/070114, filed on Jan. 12, 2009.

(51) Int. Cl. H04W 36/00

(52) U.S. Cl. 455/436

(57) ABSTRACT

The present invention relates to the wireless network communication field, and discloses a method for handover between multi-carrier cells to avoid repeated handover decisions caused by delay of the triggering event. The method includes: the source cell receives a measurement report triggered by an event reported by a served User Equipment (UE); and the source cell executs a handover decision according to measurement reports triggered by multiple events after receiving the measurement reports triggered by the multiple events within an estimated interval, and hands over the UE to the corresponding carrier of the corresponding target cell. With the present invention, the resources of the source cell and the target cell may be saved, and the handover efficiency may be improved.

### CROSS-REFERENCE TO RELATED APPLICATION

This application is a continuation of International Application No. PCT/CN2009/070114, filed on Jan. 12, 2009, which is hereby incorporated by reference in its entirety

### FIELD OF THE INVENTION

The present invention relates to the wireless network communication field, and in particular, to a method, an apparatus and a system for handover between multi-carrier cells.

### BACKGROUND OF THE INVENTION

In a LTE-A (LTE-Advance) system, carrier aggregation (Carrier Aggregation) is applied so that a UE may use more than one carrier. Carrier aggregation may be classified into three types: continuous carrier aggregation, discontinuous carrier aggregation within the same band, and discontinuous carrier aggregation within different bands. Network topologies in future may be categorized into equal-coverage topology and unequal-coverage topology. In an equal-coverage topology, carriers have the same coverage no matter which carriers are aggregated. In an unequal-coverage topology, different carriers have different coverage no matter whether they have the same or different transmit power.

In the prior art, a UE measures Reference Signal Received Power (RSRP: Reference Signal Received Power) of a neighboring cell, and judges whether the RSRP value of the neighboring cell is greater than the RSRP value of the serving cell by one offset, and, if the RSRP value of the neighboring cell is better than the RSRP value of the serving cell by one offset, the LIE triggers an A3 event and submits a measurement report triggered by the event. After receiving the measurement report, the serving cell may start a handover decision procedure.

In the process of implementing the present invention, the inventor of the present invention finds that the prior art is defective in at least the following aspects: In an LTE-A system, a cell may use multiple carriers. Different carriers may suffer different extents of fading, and the corresponding RSRP value may be measured for every carrier, which triggers the A3 event and starts the handover decision procedure repeatedly, wasting network device resources.

### SUMMARY OF THE INVENTION

Embodiments of the present invention provide a method, an apparatus, and a system for handover between multi-carrier cells to avoid frequent handover decisions in a multi-carrier system.

To handle the preceding problem, a method for handover between multi-carrier cells is provided in an embodiment of the present invention. The method includes: receiving, by a source cell, a measurement report triggered by an event of a user equipment (UE), and selecting at least one carrier of at least one target cell for the UE; judging whether target cells in measurement reports of the carriers are the same cell after receiving the measurement reports triggered by multiple events within an estimated interval; and handing over the UE to the corresponding carrier of the corresponding target cell according to the judgment result.

Another method for handover between multi-carrier cells is provided in an embodiment of the present invention. The method includes: adding information about at least one carrier to a handover request command sent by a source cell to at least one target cell when a UE is handed over between multi-carrier cells; parsing a received handover request acknowledge command to obtain information about carriers allocated by the target cell to the handover request; adding the information about the carriers allocated by the target cell to a handover command sent to the UE according to a result of the parsing; and handing over the UE to the corresponding carrier of the corresponding target cell according to the information about the allocated carriers.

An apparatus for multi-carrier handover is provided in an embodiment of the present invention. The apparatus includes: a receiving unit, configured to receive a measurement report triggered by an event of a UE; a selecting unit, configured to select at least one carrier of at least one target cell for the UE; a judging unit, configured to judge whether target cells in measurement reports of the carriers are the same cell after receiving the measurement reports triggered by multiple events within an estimated interval; and a handover processing unit, configured to hand over the UE to the corresponding carrier of the corresponding target cell.

Another apparatus for multi-carrier handover is provided in an embodiment of the present invention. The apparatus includes: a handover requesting unit, configured to add information about at least one carrier to a handover request command sent by a source cell to at least one target cell when a UE is handed over between multi-carrier cells; a handover responding unit, configured to parse a received handover request acknowledge command to obtain information about carriers allocated by the target cell to the handover request; a UE setting unit, configured to add the information about the carriers allocated by the target cell to a handover command sent to the UE according to a result of the parsing performed by the handover responding unit; and a handover processing unit, configured to hand over the UE to the corresponding carrier of the corresponding target cell according to the information about the allocated carriers.

A system for multi-carrier handover is provided in an embodiment of the present invention. The system includes: a multi-carrier handover apparatus, configured to: receive a measurement report triggered by an event reported by a served UE, execute a handover decision according to measurement reports triggered by multiple events after receiving the measurement reports triggered by the multiple events within an estimated interval, and hand over the UE to the corresponding carrier of a corresponding target cell.

The embodiments of the present invention bring at least the following benefits: Because the delay of the triggering events in the multi-carrier system is taken into account, batch handover processing and parallel handover processing can be performed according to an estimated interval and measurement report information in different handover scenarios, thus saving resources of a source eNB and a target eNB and improving the handover efficiency.

### BRIEF DESCRIPTION OF THE DRAWINGS

The drawings involved in the description of the present invention are listed in the following to enable a thorough understanding of the present invention. The drawings are part of this application, but shall not be construed as limitations on the present invention.

FIG. 1 is a flowchart showing a method for handover between multi-carrier cells according to a first embodiment of the present invention;

FIG. 2 is a flowchart showing a batch handover processing method for a UE according to an embodiment of the present invention;

FIG. 3 is a flowchart showing a parallel handover processing method for a UE according to an embodiment of the present invention;

FIG. 4 is a flowchart showing a method for handover between multi-carrier cells according to a second embodiment of the present invention;

FIG. 5 is a flowchart showing a method for handover between multi-carrier cells according to a third embodiment of the present invention;

FIG. 6 is a flowchart showing a method for handover between multi-carrier cells according to a fourth embodiment of the present invention;

FIG. 7 is an architecture diagram showing an apparatus for handover between multi-carrier cells according to the first embodiment of the present invention;

FIG. 8 is an architecture diagram showing a handover processing unit according to an embodiment of the present invention; and

FIG. 9 is an architecture diagram showing an apparatus for handover between multi-carrier cells according to the second embodiment of the present invention.

### DETAILED DESCRIPTION OF THE EMBODIMENTS

To make the objectives, technical solution and merits of the present invention clearer, the following describes the embodiments of the present invention in detail with reference to accompanying drawings. The exemplary embodiments of the present invention and the description thereof are only illustrative in nature, and shall not be construed as limitations on the present invention.

The embodiments of the present invention provide a method, an apparatus, and a system for handover between multi-carrier cells. The embodiments of the present invention are described in detail in the following with reference to accompanying drawings.

In a Long Term Evolution (LTE) system, a handover process is: First, when radio conditions of a user equipment (UE) change, the UE measures the neighboring cell, and sends a measurement report to the source cell, namely, the current cell of the UE; then, the source cell makes a decision according to the measurement report, and determines a target cell to which the UE is handed over; the source cell notifies the target cell to get ready for handover, and sends a handover command to the UE; the UE that receives the handover command is disconnected from the source cell and synchronized with the target cell, and then begins receiving or transmitting user data from or to the target cell; finally, the target cell notifies the source cell to release resources occupied by the UE.

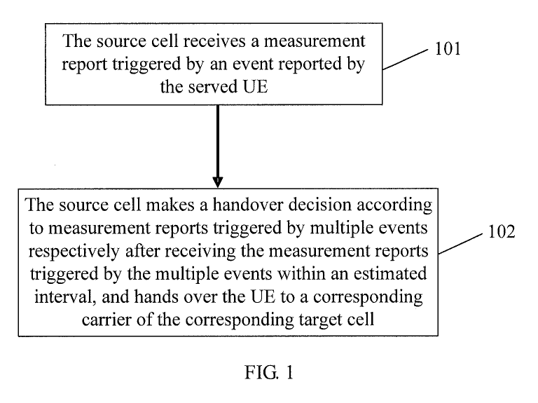

FIG. 1 is a flowchart showing a method for handover between multi-carrier cells according to a first embodiment of the present invention.

Step 101: The source cell receives a measurement report triggered by an event reported by a served user equipment (UE).

Step 102: The source cell executes a handover decision according to measurement reports triggered by multiple events after receiving the measurement reports triggered by the multiple events within an estimated interval, and hands over the UE to a corresponding carrier of the corresponding target cell.

In an embodiment of the present invention, after the source cell receives the measurement report triggered by the event reported by the served UE, the method further includes: selecting at least one carrier of at least one target cell according to the measurement report and the neighboring cell information stored on the source cell.

In an embodiment of the present invention, the measurement report includes an identifier of the event that triggers the measurement report, the carrier information of the target cell measured by the UE and the corresponding measurement value, and an identifier of the target cell.

In an embodiment of the present invention, the measurement value includes the RSRP and Reference Signal Received Quality (RSRQ: Reference Signal Received Quality) measured by the UE.

In an embodiment of the present invention, the step of selecting at least one carrier of at least one target cell includes: selecting at least one carrier of at least one target cell according to the measurement report and the neighboring cell information stored on the source cell.

In an embodiment of the present invention, the estimated interval ΔT is calculated as follows:

$$\begin{matrix}Δ RSRQ = RSRQ - {RSRQ}^{T} & ( 1 ) \\ Δ RSRP = Δ RSRQ \cdot RSSI = Δ RSRQ \cdot \frac{RSRP}{RSRQ} = ( RSRQ - {RSRQ}^{T} ) \frac{RSRP}{RSRQ} & ( 2 ) \\ Δ R = {10}^{\frac{Δ RSRP}{37.6}} & ( 3 ) \\ Δ T = \frac{Δ R}{V} & ( 4 )\end{matrix}$$

In the preceding formulas, RSRQ is RSRQ in the measurement report of the UE; RSRQ^{T} is a preset target value of the RSRQ; RSRP is RSRP in the measurement report of the UE; ΔR is a displacement of the UE in a ΔT time; and V is a displacement speed of the UE.

Both RSRQ and RSRQ^{T} may be obtained through the source eNB.

In an embodiment of the present invention, a threshold ΔT_{threshold} is set in step 102. For example, ΔT_{threshold} is set to 20 ms. If ΔT is greater than ΔT_{threshold} let ΔT be equal to ΔT_{threshold}, where ΔT_{threshold} may be obtained through the source eNB.

In an embodiment of the present invention, before step 102, the method further includes: judging whether the UE is in an LTE system or in an LTE-A system, and handing over the UE according to the handover procedure of the LTE system if the UE is in the LTE system.

In an embodiment of the present invention, after the step of judging the system that the UE belongs to or before step 102, the method further includes: judging whether the carrier used by the UE is a single carrier; and, if the carrier used by the UE is a single carrier, handing over the UE according to the handover procedure of the LTE system.

In an embodiment of the present invention, the measurement report triggered by the event of the UE includes the measurement report triggered by an A3 event.

In an embodiment of the present invention, step 102 further includes: judging whether the target cells corresponding to the carriers indicated in the measurement reports are the same cell, and, if the preceding target cells are the same cell, handing over the UE to the corresponding carrier of the target cell, namely, performing batch handover; if the preceding target cells are different cells, handing over the UE to the corresponding carrier of the corresponding target cell, namely, performing parallel handover.

In an embodiment of the present invention, the batch handover includes: adding the information about the selected carrier to the handover request command sent to a target cell; parsing the handover request response command returned by the target cell to obtain information about the carriers allocated by the target cell, namely, information about the currently available carriers in the target cell (for example, if the target cell has three carriers, but the handover can be performed between only two of the carriers due to a load restriction, the information about the allocated carriers in the handover request response command sent by the target cell includes only the information about two carries); adding the information about the allocated carriers to a handover command sent to the UE; and handing over the UE to the carriers allocated by the target cell.

In an embodiment of the present invention, the parallel handover includes: adding the information about the selected carrier to the handover request command sent to multiple target cells; parsing a handover request response command returned by the multiple target cells to obtain information about carriers allocated by the multiple target cells; adding the information about the carriers allocated by the multiple target cells to a handover command sent to the UE; and handing over the UE to the carriers allocated by the multiple target cells.

In an embodiment of the present invention, the handover between the source cell and the target cell communicates through an X2 interface between a source eNB and a target eNB, or communicates through a Mobility Management Entity (MME) that is connected to both the source eNB and the target eNB.

Through the preceding embodiments, the handover of the UE between cells may be controlled according to an estimated interval and information about the target cell, thus reducing resource consumption caused by repeated handover decisions.

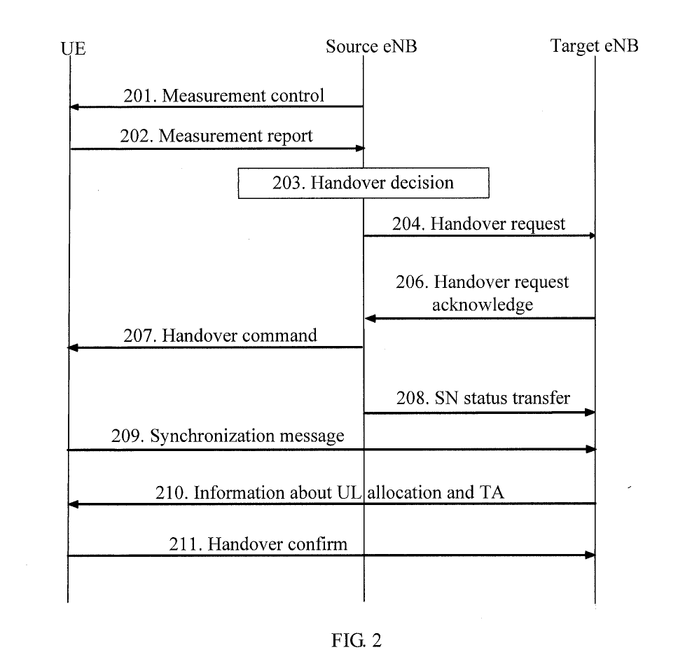

FIG. 2 is a flowchart showing a batch handover processing method for a UE according to an embodiment of the present invention.

Step 201: Measurement control (measurement control) is performed. The source eNB delivers information about the measured carrier and measured control information to a UE.

Step 202: The UE returns measurement reports (measurement reports) to the source eNB.

The source eNB of the serving cell performs uplink (UL) allocation for the UE, and the UE submits the measurement reports through the allocated uplink resources.

Step 203: The source eNB makes a handover decision (handover decision). Specifically, the source eNB processes the measurement reports and makes a handover decision about the target cell.

For details, see the first embodiment.

Step 204: The source eNB sends a handover request (handover request) to the target eNB. The handover request carries information about at least one carrier, namely, information about which carriers the UE needs to be handed over to.

Step 205: The target eNB performs admission control (admission control): The target eNB performs admission control according to the current resource status of the local cell and decides the carriers allocated to the handover request.

Step 206: The target eNB returns a handover request acknowledge (handover request acknowledge) that carries the information about the allocated carriers to the source eNB.

Step 207: The source eNB sends a handover command (handover command) to the UE.

The source eNB performs downlink allocation (DL allocation) for the UE. The allocated resources are used for delivering the handover command, and include the information about the allocated carriers and power.

Step 208: The source eNB sends a Sequence Number status transfer (SN status transfer) to the target eNB, and forwards the transmitted data to the target eNB. The target eNB buffers the data packets.

Step 209: The UE sends a synchronization (synchronization) command to the target eNB, and the UE is synchronized with the target eNB.

Step 210: The target eNB sends information about UL allocation and Timing Advance (UL allocation+TA) to the UE.

Step 211: The UE sends a handover confirm (handover confirm) command to the target eNB.

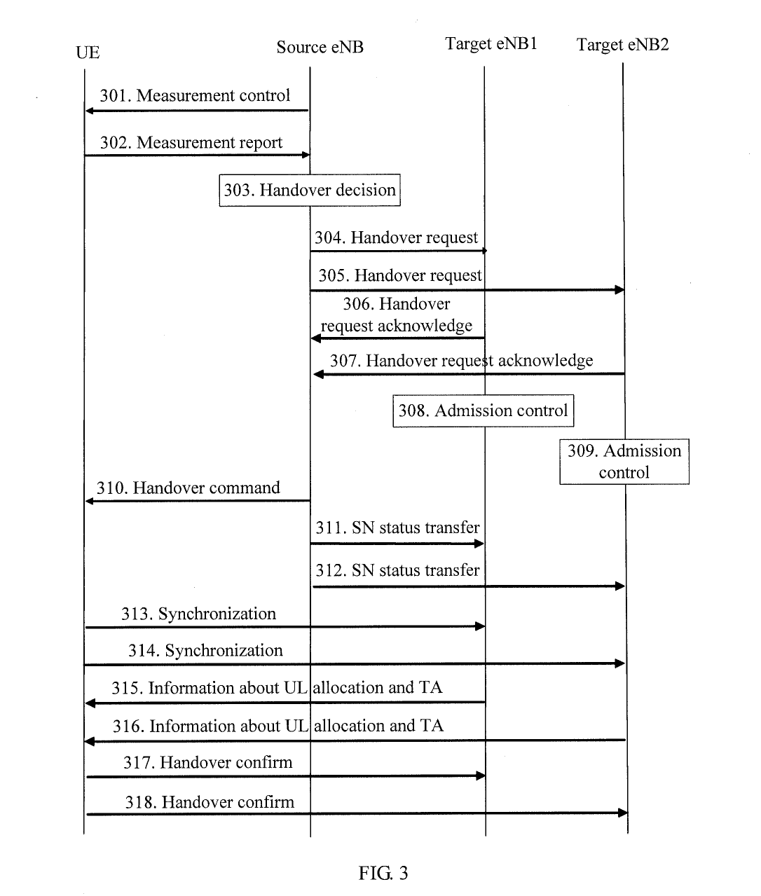

FIG. 3 is a flowchart showing a parallel handover processing method for a UE according to an embodiment of the present invention.

Step 301: The source eNB delivers a measurement control message to the UE. The measurement control message includes information about the measured carrier and the control information.

Step 302: The UE returns measurement reports to the source eNB. The source eNB of the serving cell performs UL allocation for the UE, and the UE submits the measurement reports through the allocated uplink resources.

Step 303: The source eNB makes a handover decision. Specifically, the source eNB processes the measurement reports and makes a handover decision about the target cell.

For details, see the first embodiment.

Step 304: The source eNB sends a handover request to the target eNB1. The handover request carries information about at least one carrier, namely, information about which carriers the UE needs to be handed over to.

Step 305: The source eNB sends a handover request to the target eNB2. The handover request carries information about at least one carrier, namely, information about which carriers the UE needs to be handed over to.

Step 306: The target eNB1 performs admission control: The target eNB1 performs admission control according to the current resource status of the local cell and decides the carriers allocated to the handover request.

Step 307: The target eNB1 returns a handover request acknowledge command that carries the information about the allocated carriers to the source eNB.

Step 308: The target eNB2 performs admission control: The target eNB2 performs admission control according to the current resource status of the local cell and decides the carriers allocated to the handover request.

Step 309: The target eNB2 returns a handover request acknowledge command that carries the information about the allocated carriers to the source eNB.

Step 310: The source eNB sends a handover command to the UE, and performs DL allocation for the UE. The allocated resources are used for delivering the handover command, and include the information about the allocated carriers and power.

Step 311: The source eNB sends an SN status transfer message to the target eNB1, and forwards the transmitted data to the target eNB1. The target eNB1 buffers the data packets.

Step 312: The source eNB sends an SN status transfer message to the target eNB2, and forwards the transmitted data to the target eNB2. The target eNB2 buffers the data packets.

Step 313: The UE sends a synchronization command to the target eNB1, and the UE is synchronized with the target eNB1.

Step 314: The UE sends a synchronization command to the target eNB2, and the UE is synchronized with the target eNB2.

Step 315: The target eNB1 sends information about UL allocation and TA to the UE.

Step 316: The target eNB2 sends information about UL allocation and TA to the UE (UL allocation+TA).

Step 317: The UE sends a handover confirm command to the target eNB1.

Step 318: The UE sends a handover confirm command to the target eNB2.

In an embodiment of the present invention, the preceding signaling messages are transmitted through an X2 interface between the source eNB and the target eNB.

In an embodiment of the present invention, the information about at least one carrier selected is added to a handover request command sent by the source eNB to an MME. The MME sends the handover request command to an eNB of the target cell. The handover request acknowledgecommand returned by the eNB of the target cell to the MME carries the information about the carrier allocated to the handover request. The MME sends the handover request acknowledge command to the source eNB.

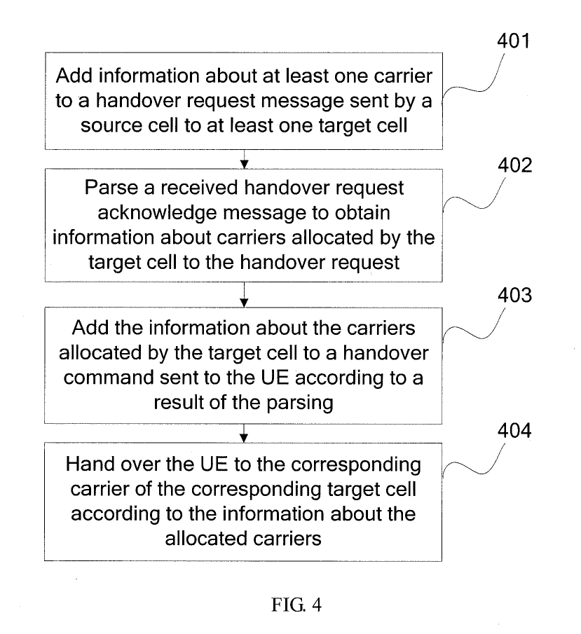

FIG. 4 is a flowchart showing a method for handover between multi-carrier cells according to a second embodiment of the present invention.

When a UE is handed over between multi-carrier cells, the method includes the following steps:

Step 401: Add information about at least one carrier to a handover request command sent by a source cell to at least one target cell.

Step 402: Parse a received handover request acknowledge command to obtain information about carriers allocated by the target cell to the handover request.

Step 403: Add the information about the carriers allocated by the target cell to a handover command sent to the UE according to a result of the parsing.

Step 404: Hand over the UE to the corresponding carrier of the corresponding target cell according to the information about the allocated carriers.

Through the preceding embodiment, the UE may be handed over between multi-carrier cells in a multi-carrier system, so that the UE can be handed over to multiple carriers of a neighboring cell.

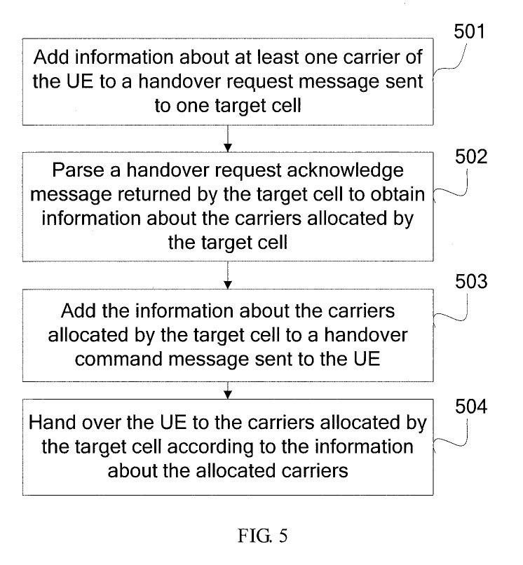

FIG. 5 is a flowchart showing a method for handover between multi-carrier cells according to a third embodiment of the present invention.

Step 501: Add information about at least one carrier of the UE into a handover request command sent to a target cell.

Step 502: Parse a handover request acknowledge command returned by the target cell to obtain information about carriers allocated by the target cell;

Step 503: Add the information about the allocated carriers to a handover command sent to the UE.

Step 504: Hand over the UE to the carriers allocated by the target cell according to the information about the allocated carriers.

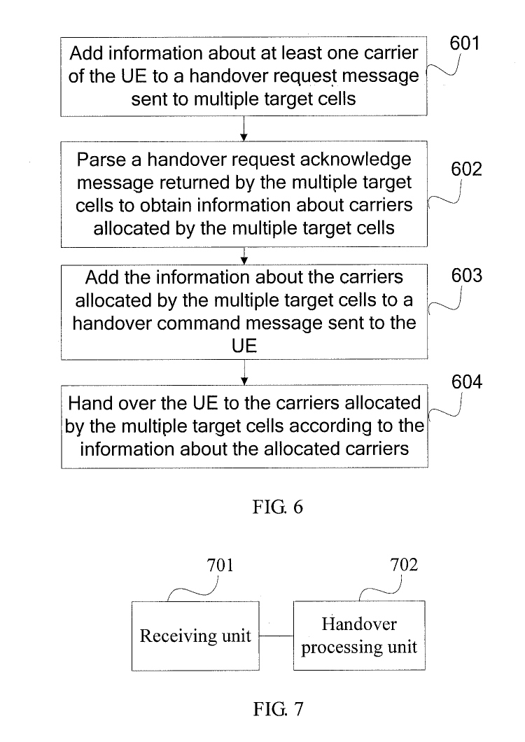

FIG. 6 is a flowchart showing a method for handover between multi-carrier cells according to a fourth embodiment of the present invention.

Step 601: Add information about at least one carrier of the UE to a handover request command sent to multiple target cells.

Step 602: Parse a handover request acknowledge command returned by the multiple target cells to obtain information about carriers allocated by the multiple target cells.

Step 603: Add the information about the carriers allocated by the multiple target cells to a handover command sent to the UE.

Step 604: Hand over the UE to the carriers allocated by the multiple target cells according to the information about the allocated carriers.

In an embodiment of the present invention, the source cell communicates with the target cell through an X2 interface between the source eNB and the target eNB.

In an embodiment of the present invention, the information about at least one carrier selected is added to a handover request command sent by the source eNB to a mobility management entity (MME). The MME sends the handover request command to an eNB of the target cell. The handover request acknowledge command returned by the eNB of the target cell to the MME carries the information about the carriers allocated to the handover request. The MME sends the handover request acknowledge command to the source eNB.

In an embodiment of the present invention, the information about the carriers allocated by one or more target cells added to the handover command sent to the UE includes the information about the power of the carriers.

FIG. 7 is an architecture diagram showing an apparatus for handover between multi-carrier cells according to the first embodiment of the present invention.

The apparatus includes:

a receiving unit 701, configured to receive a measurement report triggered by an event reported by a served UE; and

a handover processing unit 702, configured to: execute a handover decision according to measurement reports triggered by multiple events after receiving the measurement reports triggered by the multiple events within an estimated interval, and hand over the UE to the corresponding carrier of the corresponding target cell.

In an embodiment of the present invention, the apparatus further includes a selecting unit, configured to select at least one carrier of at least one target cell for the UE according to output of the receiving unit.

In an embodiment of the present invention, the handover processing unit 702 is further configured to: judge whether the target cells corresponding to the carriers indicated in the measurement reports are the same cell, and hand over the UE to the corresponding carrier of the target cell according to the judgment result. In an embodiment of the present invention, the handover processing unit 702 calculates the estimated interval ΔT through:

$$\begin{matrix}Δ RSRQ = RSRQ - {RSRQ}^{T} & ( 1 ) \\ Δ RSRP = Δ RSRQ \cdot RSSI = Δ RSRQ \cdot \frac{RSRP}{RSRQ} = ( RSRQ - {RSRQ}^{T} ) \frac{RSRP}{RSRQ} & ( 2 ) \\ Δ R = {10}^{\frac{Δ RSRP}{37.6}} & ( 3 ) \\ Δ T = \frac{Δ R}{V} & ( 4 )\end{matrix}$$

In the preceding formulas, RSRQ is RSRQ in the measurement report of the UE; RSRQ^{T} is a preset target value of the RSRQ; RSRP is RSRP in the measurement report of the UE; ΔR is a displacement of the UE in a ΔT time; and V is a displacement speed of the UE.

Both RSRQ and RSRQ^{T} may be obtained through the source eNB.

In an embodiment of the present invention, the handover processing unit 702 is further configured to compare the ΔT value output by the calculating unit with the threshold ΔT_{threshold}. If ΔT is greater than ΔT_{threshold}, let ΔT be equal to ΔT_{threshold}.

In an embodiment of the present invention, the apparatus further includes a system detecting unit, configured to judge whether the UE is in an LTE system or an LTE-A system according to the measurement reports, and hand over the UE according to the handover procedure of the LTE system if the UE is in an LTE system.

In an embodiment of the present invention, the apparatus further includes a carrier detecting unit, configured to judge whether the carrier used by the UE is a single carrier according to the measurement reports of the UE, and, if the preceding carrier is a single carrier, hand over the UE according to the handover procedure of the LTE system.

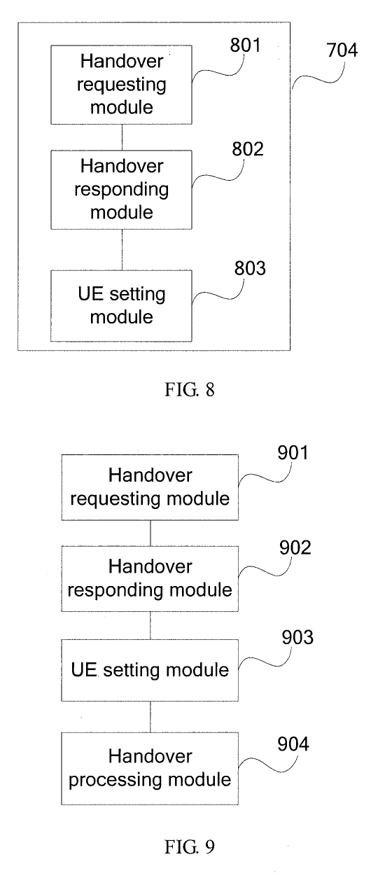

FIG. 8 is an architecture diagram showing a handover processing unit according to an embodiment of the present invention.

The handover processing unit includes a handover requesting unit 801, a handover responding unit 802, and a UE setting unit 803.

The handover requesting unit 801 is configured to add information about at least one carrier selected to a handover request command sent by a source cell to a target cell. In this embodiment, in the information about a target cell stored in the source cell, the target cell may support three carriers. The information about the three carriers is added to the handover request command. The handover requesting unit 801 may also add information about at least one carrier selected to a handover request command sent to multiple target cells. Under this circumstance, the processing is similar to the scenario of sending a handover request command to one target cell.

The handover responding unit 802 is configured to parse at least one received handover request acknowledge command to obtain information about carriers allocated by the target cell to the handover request. In this embodiment, the target cell may support only two of three carriers in the handover request command currently. Therefore, the handover request acknowledge command carries information about the currently supported carriers. The handover responding unit 802 may also receive the handover request acknowledge command from multiple target cells. Under this circumstance, the parsing process is similar to the scenario of receiving a handover request acknowledge command from one target cell.

The UE setting unit 803 is configured to add the information about the power of the carriers allocated by the target cell to a handover command sent to the UE according to a result of the parsing performed by the handover responding unit 802. In this embodiment, if two carriers are allocated by the target cell, the information about the power of the two carriers is added to the handover command.

In an embodiment of the present invention, when no X2 interface exists between the source cell and the target cell:

The handover requesting unit 801 is configured to add information about at least one carrier selected to a handover request command sent by a source eNB to an MME.

The MME sends the handover request command to a target eNB of the target cell. The handover request acknowledge command returned by the target eNB of the target cell to the MME carries the information about the carriers allocated to the handover request. The MME sends the handover request acknowledge command to the source eNB.

The handover responding unit 802 is configured to parse a received handover request acknowledge command to obtain information about carriers allocated by the target cell to the handover request.

In an embodiment of the present invention, when an X2 interface exists between the source cell and the target cell:

The handover requesting unit 801 is configured to add information about at least one carrier selected to a handover request command sent by a source eNB to a target eNB of a target cell.

The target eNB of the target cell adds the information about the carriers allocated to the handover request to the handover request acknowledge command returned to the source eNB.

The handover responding unit 802 is configured to parse a received handover request acknowledge command to obtain information about carriers allocated by the target cell to the handover request.

FIG. 9 is an architecture showing an apparatus for handover between multi-carrier cells according to the second embodiment of the present invention.

The apparatus includes a handover requesting unit 901, a handover responding unit 902, a UE setting unit 903, and a handover processing unit 904.

The handover requesting unit 901 is configured to add information about at least one carrier selected to a handover request command sent by a source cell to a target cell. In this embodiment, in the information about a target cell stored in the source cell, the target cell may support three carriers. The information about the three carriers is added to the handover request command. The handover requesting unit 901 may also add information about at least one carrier selected to a handover request command sent to multiple target cells. Under this circumstance, the processing is similar to the scenario of sending a handover request command to one target cell.

The handover responding unit 902 is configured to parse at least one received handover request acknowledge command to obtain information about carriers allocated by the target cell to the handover request. In this embodiment, the target cell may support only two of three carriers in the handover request command currently. Therefore, the handover request acknowledge command carries information about the currently supported carriers. The handover responding unit 902 may also receive the handover request acknowledge command from multiple target cells. Under this circumstance, the parsing process is similar to the scenario of receiving a handover request acknowledge command from one target cell.

The UE setting unit 903 is configured to add the information about the power of the carriers allocated by the target cell to a handover command sent to the UE according to a result of the parsing performed by the handover responding unit 902. In this embodiment, if two carriers are allocated by the target cell, the information about the power of the two carriers is added to the handover command.

The handover processing unit 904 is configured to hand over the UE to the corresponding carrier of the corresponding target cell according to the information about the allocated carriers.

In an embodiment of the present invention, when no X2 interface exists between the source cell and the target cell:

The handover requesting unit 901 is configured to add information about at least one carrier selected to a handover request command sent by a source eNB to a mobility management entity (MME).

The MME sends the handover request command to a target eNB of the target cell. The handover request acknowledge command returned by the target eNB of the target cell to the MME carries the information about the carriers allocated to the handover request. The MME sends the handover request acknowledge command to the source eNB.

The handover responding unit 902 is configured to parse a received handover request acknowledge command to obtain information about carriers allocated by the target cell to the handover request.

In an embodiment of the present invention, when an X2 interface exists between the source cell and the target cell:

The handover requesting unit 901 is configured to add information about at least one carrier selected to a handover request command sent by a source eNB to a target eNB of a target cell.

The target eNB of the target cell adds the information about the carriers allocated to the handover request to the handover request acknowledge command returned to the source eNB.

The handover responding unit 902 is configured to parse a received handover request acknowledgecommand to obtain information about carriers allocated by the target cell to the handover request.

A system for multi-carrier handover provided in an embodiment of the present invention includes an apparatus for multi-carrier handover, configured to: receive a measurement report triggered by an event reported by a served UE, execute a handover decision according to measurement reports triggered by multiple events after receiving the measurement reports triggered by the multiple events within an estimated interval, and hand over the UE to corresponding carrier of a corresponding target cell.

The embodiments of the present invention avoid signaling overload on the X2 interface. Emulation data shows that by using the method disclosed herein, the signaling load caused by handover decreases by 41%, thus saving the transmit power of the source eNB and the target eNB. As regards the signaling load caused by handover, the transmit power decreases by 41%. The processing resources of the source eNB and the target eNB are saved. For the handover based on the S1 interface, the signaling load on the S1 interface is avoided, thus saving the processing capacity of the MME and relieving pressure on the core network.

The preceding embodiments describe the objectives, technical solution and benefits of the present invention in detail. Although the invention has been described through some exemplary embodiments, the invention is not limited to such embodiments. It is apparent that those skilled in the art can make modifications, equivalent replacements and variations to the invention without departing from the spirit and scope of the invention. The invention is intended to cover the modifications and variations provided that they fall within the protection scope defined by the following claims or their equivalents.

What is claimed is:

1. A method for handover between multi-carrier cells, comprising:
adding information about at least one carrier to a handover request command sent by a source cell to at least one target cell when a User Equipment (UE) is handed over between multi-carrier cells;
parsing a received handover request acknowledge command to obtain information about carriers allocated by the target cell to the handover request;
adding the information about the carriers allocated by the target cell to a handover command sent to the UE according to a result of the parsing; and
handing over the UE to the corresponding carrier of the corresponding target cell according to the information about the allocated carriers.

2. The method according to claim 1, further comprising:
adding information about at least one carrier of the UE to the handover request command sent to one target cell;
parsing the handover request acknowledge command returned by the target cell to obtain the information about the carriers allocated by the target cell;
adding the information about the carriers allocated by the target cell to the handover command sent to the UE; and
handing over the UE to the carriers allocated by the target cell according to the information about the allocated carriers.

3. The method according to claim 1, further comprising:
adding information about at least one carrier of the UE to the handover request command sent to multiple target cells;
parsing the handover request acknowledge command returned by the multiple target cells to obtain the information about carriers allocated by the multiple target cells;
adding the information about the carriers allocated by the multiple target cells to the handover command sent to the UE; and
handing over the UE to the carriers allocated by the multiple target cells according to the information about the allocated carriers.

4. An apparatus for multi-carrier handover, wherein:
when a User Equipment (UE) is handed over between multi-carrier cells, the apparatus comprises:
a handover requesting unit, configured to add information about at least one carrier to a handover request command sent by a source cell to at least one target cell;
a handover responding unit, configured to parse a received handover request acknowledge command to obtain information about carriers allocated by the target cell to the handover request;
a UE setting unit, configured to add the information about the carriers allocated by the target cell to a handover command sent to the UE according to a result of the parsing performed by the handover responding unit; and
a handover processing unit, configured to hand over the UE to the corresponding carrier of the corresponding target cell according to the information about the allocated carriers.

5. The apparatus according to claim 4, wherein:
the handover requesting unit is further configured to: adding information about at least one carrier of the UE to the handover request command sent to one target cell;
the handover responding unit is further configured to: parsing the handover request acknowledge command returned by the target cell to obtain the information about the carriers allocated by the target cell;
the UE setting unit is further configured to: adding the information about the carriers allocated by the target cell to the handover command sent to the UE;
the handover processing unit is further configured to: handing over the UE to the carriers allocated by the target cell according to the information about the allocated carriers.

6. The apparatus according to claim 4, wherein:
the handover requesting unit is further configured to: adding information about at least one carrier of the UE to the handover request command sent to multiple target cells;
the handover responding unit is further configured to: parsing the handover request acknowledge command returned by the multiple target cells to obtain the information about carriers allocated by the multiple target cells;
the UE setting unit is further configured to: adding the information about the carriers allocated by the multiple target cells to the handover command sent to the UE;
the handover processing unit is further configured to: handing over the UE to the carriers allocated by the multiple target cells according to the information about the allocated carriers.

7. A computer program product, characterised in, comprising computer program code, which, when executed by a computer unit, will cause the computer unit to perform the steps of a user terminal according to claim 1.
